(19) United States
(12) Patent Application Publication
(10) Pub. No.: US 2022/0196181 A1
(43) Pub. Date: Jun. 23, 2022

(54) INFLATABLE SYSTEMS WITH ELECTRO-PNEUMATIC VALVE MODULES

(71) Applicant: GOODRICH CORPORATION, Charlotte, NC (US)

(72) Inventors: Nikhil Anthony Saldanha, Bangalore (IN); Poly Puthur John, Trivandrum (IN)

(73) Assignee: GOODRICH CORPORATION, Charlotte, NC (US)

(21) Appl. No.: 17/193,750

(22) Filed: Mar. 5, 2021

(30) Foreign Application Priority Data
Dec. 23, 2020 (IN) 202041056067

(51) Int. Cl. F16K 31/42; F16K 17/04; B64D 25/14

(52) U.S. Cl. CPC F16K 31/426; B64D 25/14; F16K 17/0466

(57) ABSTRACT

A valve assembly may comprise: a housing cap; a valve housing having an inlet port, an outlet port, and a pilot pressure inlet port, the inlet port disposed axially opposite the housing cap; a poppet defining an axial surface and a radially outer surface, the poppet including a first radial groove disposed in the radially outer surface; a first dynamic radial seal disposed in the first radial groove and in intimate contact with a radially inner surface of the valve housing, the first dynamic radial seal configured to maintain unobstructed contact with the radially inner surface of the valve housing in response to the poppet translating axially from an open position to a closed position.

### CROSS-REFERENCE TO RELATED APPLICATIONS

This application is a non-provisional of, and claims priority to, and the benefit of India Provisional Application No. 202041056067 with DAS code 33DE, entitled “INFLATABLE SYSTEMS WITH ELECTRO-PNEUMATIC VALVE MODULES,” filed on Dec. 23, 2020, which is hereby incorporated by reference in its entirety.

### FIELD

The present disclosure relates to inflatable systems and, in particular, to inflatable systems with electro-pneumatic systems and assemblies for use in aircraft evacuation systems.

### BACKGROUND

An emergency evacuation assembly may be used to exit an aircraft absent a jet way or other suitable means of egress for passengers. The evacuation assembly may include an inflatable slide. Inflation valves may be used in conjunction with a high pressure stored gas that is controllably released to inflate an object, such as a raft, lifejacket, emergency slide, or the like. Inflation valves may be flow isolation valves actuated by electrical or mechanical arrangements but are typically single opening action valves meaning that they may only be used one time.

### SUMMARY

A valve assembly is disclosed herein. The valve assembly may comprise: a housing cap; a valve housing having an inlet port, an outlet port, and a pilot pressure inlet port, the inlet port disposed axially opposite the housing cap; a poppet defining an axial surface and a radially outer surface, the poppet including a first radial groove disposed in the radially outer surface; a first dynamic radial seal disposed in the first radial groove and in intimate contact with a radially inner surface of the valve housing, the first dynamic radial seal configured to maintain unobstructed contact with the radially inner surface of the valve housing in response to the poppet translating axially from an open position to a closed position.

In various embodiments, the valve assembly may further comprise a face seal, wherein: the poppet further comprises an annular face groove disposed in the axial surface, and the face seal is disposed in the annular face groove. The face seal may be configured to seal the inlet port in response to the valve assembly being in the closed position. In various embodiments, the valve assembly further comprise a second dynamic radial seal, wherein: the poppet further comprises a second radial groove disposed in the radially outer surface, the second radial groove being spaced apart axially from the first radial groove, and the second dynamic radial seal is disposed in the second radial groove. The valve assembly may further comprise a vent fitting coupled to the valve housing, the vent fitting disposed axially between the first dynamic radial seal and the second dynamic radial seal. The vent fitting may remain axially between the first dynamic radial seal and the second dynamic radial seal in response to the poppet translating axially to open the valve assembly. The housing cap and the poppet may at least partially define a command cavity. The command cavity may have fluid communication with the pilot pressure inlet port. The valve assembly may be configured to bias the poppet axially towards the inlet port in response to the command cavity and the inlet port being exposed to similar pressure from a pressurized fluid. The valve assembly may further comprise a biasing mechanism configured to bias the poppet axially towards the inlet port. The biasing mechanism may comprise a compression spring extending from the housing cap to the poppet. The valve housing may further comprise an internal pilot conduit and a command feed conduit. The internal pilot conduit may extend from the inlet port to a solenoid inlet port of a three-way normally open solenoid valve. The command feed conduit may extend from a solenoid outlet port of the three-way normally open solenoid valve to the pilot pressure inlet port of the inlet port. In various embodiments, the three-way normally open solenoid valve may further comprise: a plunger configured to seal a vent port in response to the three-way normally open solenoid valve being in a de-energized state; a poppet rod extending axially from the plunger to a second poppet, the poppet rod extending towards the solenoid inlet port; and an inlet port face seal coupled to the second poppet, the inlet port face seal configured to seal the solenoid inlet port in response to the three-way normally open solenoid valve being in an energized state.

An inflation system is disclosed herein. The inflation system may comprise: a compressed fluid source; an aspirator; a three-way normally open solenoid valve having a first inlet port, a first outlet port, and a first vent port, the compressed fluid source in fluid communication with the first inlet port; and a pneumatic valve, comprising: a housing cap disposed at a first axial end of the pneumatic valve; a valve housing defining a second inlet port, a second outlet port, and a pilot pressure inlet port, the first outlet port of the three-way normally open solenoid valve in fluid communication with the pilot pressure inlet port, the compressed fluid source in fluid communication with the second inlet port, and the second outlet port in fluid communication with the aspirator, the second inlet port disposed at a second axial end of the pneumatic valve, the second axial end being axially opposite the first axial end; and a poppet disposed axially between the housing cap and the second inlet port, the poppet configured to seal the second inlet port in response to the three-way normally open solenoid valve being in a de-energized sate, and the poppet configured to translate axially toward the housing cap and fluidly couple the second inlet port and the second outlet port in response to the three-way normally open solenoid valve being an energized state.

In various embodiments, the inflation system may further comprise an inflatable slide coupled to the aspirator. In various embodiments, the inflation system may further comprise a first dynamic radial seal coupled to the poppet, the first dynamic radial seal being in unobstructed contact with a radially inner surface of the valve housing, the first dynamic radial seal configured to maintain intimate contact with the radially inner surface in response to translating axially within the valve housing. The pneumatic valve may further comprise a face seal coupled to the poppet and configured to seal the second inlet port in response to the three-way normally open solenoid valve being in a de-energized state. In various embodiments, the pneumatic valve may further comprise a second dynamic radial seal and a vent fitting, the second dynamic radial seal being spaced apart axially from the first dynamic radial seal and coupled to the poppet , the vent fitting coupled to the valve housing and disposed axially between the first dynamic radial seal and the second dynamic radial seal.

A method for using a pneumatic valve is disclosed herein. The method may comprise:

receiving, from a pressurized fluid source and through a three-way normally open solenoid valve, a pressurized fluid in a command cavity of the pneumatic valve, the command cavity being defined by a housing cap, a valve housing, and poppet disposed in the valve housing; receiving, from the pressurized fluid source and through an inlet port defined by the valve housing, the pressurized fluid; sealing the inlet port via an annular face seal in response to a first pressure force in the command cavity being greater than a second pressure force in the inlet port; and translating the poppet axially within the valve housing to fluidly couple the inlet port to an outlet port defined by the valve housing in response to the three-way normally open solenoid valve being energized , the pneumatic valve comprising a first dynamic radial seal coupled to the poppet and in intimate contact with a radially inner surface of the valve housing, the first dynamic radial seal configured to maintain intimate contact with the radially inner surface in response to translating axially.

In various embodiments, the method may further comprise translating, via a biasing mechanism, the poppet axially towards the inlet port in response to the three-way normally open solenoid valve being de-energized. The biasing mechanism may comprise a compression spring disposed between the housing cap and the poppet. The method may further comprise venting, via a vent fitting coupled to the valve housing, leaked fluid in response to the pressurized fluid leaking past the first dynamic radial seal, the vent fitting being disposed axially between the first dynamic radial seal and a second dynamic radial seal.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the figures, wherein like numerals denote like elements.

FIG. 1 illustrates an aircraft having an evacuation assembly, in accordance with various embodiments;

FIG. 2 illustrates a perspective view of an evacuation slide in a deployed position, in accordance with various embodiments;

FIG. 3 illustrates a schematic view of an inflation system having a valve module, in accordance with various embodiments;

FIG. 4A illustrates a schematic view of a valve module with a detail view of a pneumatic valve with the pneumatic valve in a closed position, in accordance with various embodiments;

FIG. 4B illustrates a schematic view of a valve module with a detail view of a pneumatic valve with the pneumatic valve in an open position, in accordance with various embodiments

FIG. 5A illustrates a schematic view of a valve module with a detail view of a pneumatic valve with the pneumatic valve in a closed position, in accordance with various embodiments;

FIG. 5B illustrates a schematic view of a valve module with a detail view of a pneumatic valve with the pneumatic valve in an open position, in accordance with various embodiments;

FIG. 6A illustrates a vent fitting in a closed position, in accordance with various embodiments;

FIG. 6B illustrates a vent fitting in an open position, in accordance with various embodiments;

FIG. 7A illustrates a solenoid valve of a valve module in a de-energized state, in accordance with various embodiments;

FIG. 7B illustrates a solenoid valve of a valve module in an energized state, in accordance with various embodiments; and

FIG. 8 illustrates a valve assembly with a solenoid valve and a pneumatic valve, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the exemplary embodiments of the disclosure, it should be understood that other embodiments may be realized and that logical changes and adaptations in design and construction may be made in accordance with this disclosure and the teachings herein. Thus, the detailed description herein is presented for purposes of illustration only and not limitation. The steps recited in any of the method or process descriptions may be executed in any order and are not necessarily limited to the order presented.

Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option.

Surface cross hatching lines may be used throughout the figures to denote different parts but not necessarily to denote the same or different materials. Throughout the present disclosure, like reference numbers denote like elements. Accordingly, elements with like element numbering may be shown in the figures but may not necessarily be repeated herein for the sake of clarity.

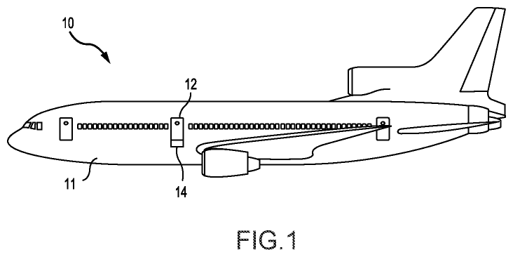

Referring now to FIG. 1, an aircraft 10 is shown. Aircraft 10 may include a fuselage 11 having plurality of exit doors, including an exit door 12. Aircraft 10 may include one or more evacuation assemblies positioned near a corresponding exit door. For example, aircraft 10 includes an evacuation assembly 14 positioned near exit door 12. In the event of an emergency, exit door 12 may be opened by a passenger or crew member of aircraft 10. In various embodiments, evacuation assembly 14 may deploy in response to exit door 12 being opened or in response to another action taken by a passenger or crew member such as depression of a button or actuation of a lever.

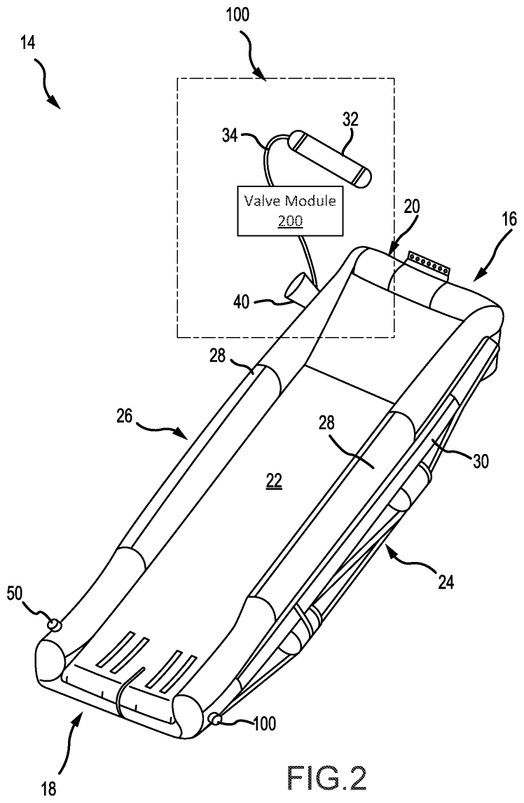

Referring now to FIG. 2, a perspective view of an evacuation assembly 14 is illustrated with an evacuation slide 16 of evacuation assembly 14 in an inflated or “deployed” position. Although described herein with respect to an inflatable evacuation slide herein, the present disclosure is not limited in this regard. For example, any inflatable system (e.g., an object, a raft, a lifejacket, etc.) with a valve system is within the scope of this disclosure.

In accordance with various embodiments, evacuation slide 16 includes a toe end 18 and a head end 20 opposite toe end 18. Head end 20 may be coupled to an aircraft structure (e.g., fuselage 11 in FIG. 1). In various embodiments, evacuation slide 16 is an inflatable slide. Evacuation slide 16 includes a sliding surface 22 and an underside surface 24 opposite sliding surface 22. Sliding surface 22 extends from head end 20 to toe end 18. During an evacuation event, underside surface 24 may be oriented toward an exit surface (e.g., toward the ground or toward a body of water). Evacuation slide 16 is illustrated as a single lane slide. However, evacuation slide 16 may comprise any number of lanes.

Evacuation slide 16 may comprise an inflatable rail structure 26. Inflatable rail structure 26 includes a first (or upper) inflatable tube 28. In various embodiments, inflatable rail structure 26 may include a second (or lower) inflatable tube 30. First inflatable tube 28 and second inflatable tube 30 may extend between head end 20 and toe end 18. Upon deployment of evacuation slide 16, first inflatable tube 28 may be located generally over or above second inflatable tube 30, such that second inflatable tube 30 is located generally between first inflatable tube 28 and the exit surface.

Evacuation assembly 14 may include a compressed fluid source, or charge cylinder, 32. Compressed fluid source 32 is configured to deliver a pressurized gas to inflate evacuation slide 16. Compressed fluid source 32 may be fluidly coupled to evacuation slide 16. For example, compressed fluid source 32 may be fluidly coupled to inflatable rail structure 26. In various embodiments, compressed fluid source 32 may be fluidly coupled to evacuation slide 16 via a hose, or conduit, 34. In response to receiving the gas from compressed fluid source 32, evacuation slide 16 begins to inflate.

In various embodiments, evacuation assembly 14 may include one or more aspirator(s) 40 fluidly coupled between compressed fluid source 32 and evacuation slide 16. In various embodiments, first inflatable tube 28 and second inflatable tube 30 may each have a dedicated aspirator 40, such that a first aspirator is attached, or coupled, to first inflatable tube 28 and a second aspirator is attached, or coupled, to second inflatable tube 30. Aspirator 40 may be configured to entrain ambient air with gas output from compressed fluid source 32 (referred to herein as primary gas). For example, in response to deployment of evacuation slide 16, primary gas from compressed fluid source 32 may flow into aspirator 40. This primary gas flow may cause aspirator 40 to draw in a secondary gas (i.e., ambient air) from the environment. The primary gas flow and the secondary gas may be directed into inflatable rail structure 26. In response to receiving the primary gas and the environmental gas, evacuation slide 16 begins to inflate.

In various embodiments, evacuation assembly 14 further comprises an inflation system 100. The inflation system 100 comprises the compressed fluid source 32, the aspirator 40, and a valve module 200. In various embodiments, the inflation system 100 may be self-monitoring and self-sustained as described further herein. In various embodiments, the inflation system 100 may utilize inflatable stretch feedback and inflation flow shut off control with the aspirator 40 to achieve a pre-set inflatable stretch for the evacuation slide 16. In various embodiments, typical valve modules 200 for inflation systems involve sliding O-ring seals which may pass a valve outlet aperture upon each cycle between valve opening and valve closing. In this regard, the sliding O-ring seal may wear and/or limit an operating cycle life for a typical inflation system. In various embodiments, an inflation system 100, as described further herein, includes a valve module with improved leakage control. Thus, the inflation system 100 may result in greater operating cycle life for the valve module 200 relative to typical inflation systems, in accordance with various embodiments.

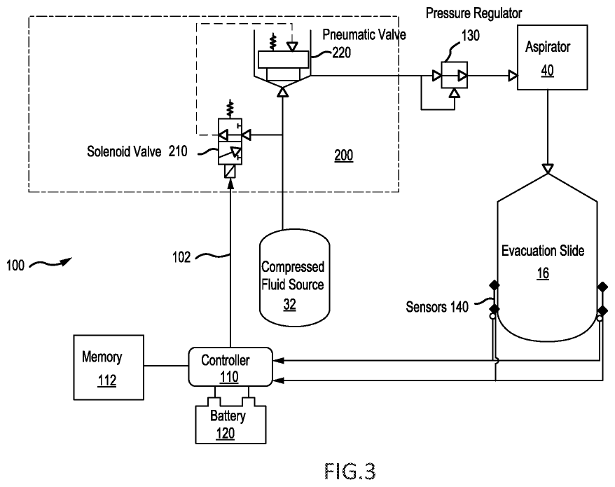

Referring now to FIG. 3, a schematic view of an inflation system 100 with a valve module 200 is illustrated, in accordance with various embodiments. In various embodiments, the inflation system 100 comprises a controller 110, a battery 120, a pressure regulator 130, the compressed fluid source 32, the aspirator 40, the evacuation slide 16, sensors 140, and a valve module 200. In various embodiments, the compressed fluid source 32 is in fluid communication with aspirator 40 through the valve module 200 and the pressure regulator 130. In various embodiments, the valve module 200 may eliminate a pressure relief valve from a typical inflation system, in accordance with various embodiments.

The controller 110 of the inflation system 100 may include one or more logic devices such as one or more of a central processing unit (CPU), an accelerated processing unit (APU), a digital signal processor (DSP), a field programmable gate array (FPGA), an application specific integrated circuit (ASIC), or the like. In various embodiments, the controller 110 may further include any non-transitory memory known in the art. The memory may store instructions usable by the logic device to perform operations.

The inflation system 100 may further include a database or remote memory 112. The database 112 may be located on a same aircraft as the inflation system 100 or may be located remote from the inflation system 100. The controller 110 may communicate with the database 112 via any wired or wireless protocol. In that regard, the controller 110 may access data stored in the database 112. The database 112 may store pre-determined stretch thresholds of the inflation system 100 and may store instructions for the valve module 200 of the inflation system 100 that are associated with predetermined stretch threshold. For example, the valve module 200 may be actuated in response to the predetermined stretch threshold being exceeded, in accordance with various embodiments.

The inflation system 100 may further include two or more sensors 140. For example, the sensor may include at least one stretch sensor and at least one temperature sensor in operable communication with the controller 110. Each of the sensors in the two or more sensors 140 may communicate with the controller 110. In various embodiments, the controller 110 may compare the stretch value from the stretch sensor and the temperature sensor (i.e., to accommodate for any thermal drift in the stretch sensor output with varying ambient temperatures) and compare the stretch value to the predetermined stretch threshold, in accordance with various embodiments.

In various embodiments, the valve module 200 comprises a solenoid valve 210 and a pneumatic valve 220. In various embodiments, the solenoid valve 210 is in communication with the controller 110. In this regard, the controller 110 is configured to energize the solenoid valve 210, in accordance with various embodiments. The solenoid valve 210 may be open in an unenergized state and closed in an energized state, as described further herein.

In various embodiments, the compressed fluid source 32 is fluidly coupled to the solenoid valve 210 and the pneumatic valve 220. In various embodiments, the pneumatic valve 220 may be in a closed position in response to the solenoid valve being open (i.e., when the solenoid valve is not energized), and the pneumatic valve 220 may be in an open position in response to the solenoid valve being closed (i.e., when the solenoid valve is energized). In various embodiments, in response to the pneumatic valve 220 being in an open position, the compressed fluid source 32 may be fluidly coupled to the evacuation slide 16 through the pressure regulator 130 and the aspirator 40.

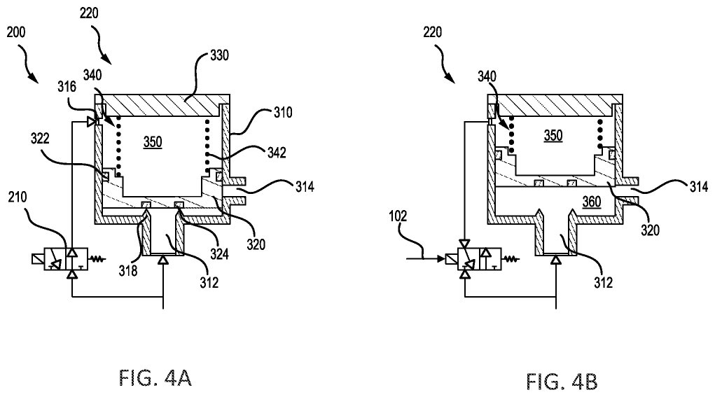

Referring now to FIG. 4A, a schematic view of the valve module 200 with a detail cross-sectional view of the pneumatic valve 220 is illustrated in a closed position, in accordance with various embodiments. In various embodiments, the pneumatic valve 220 includes a valve housing 310 and a poppet 320. In various embodiments, the valve housing 310 and the poppet 320 are both annular in shape. In various embodiments, the valve housing defines an inlet port 312, an outlet port 314, and a pilot pressure inlet port 316. In various embodiments, the pneumatic valve 220 further comprises a housing cap 330. The housing cap 330 may be disposed distal to the inlet port 312 in accordance with various embodiments. In various embodiments, the poppet 320 is disposed axially between the housing cap 330 and the inlet port 312.

In various embodiments, the pneumatic valve 220 further comprises a biasing mechanism 340 configured to supply a biasing force in response to the poppet 320 travelling axially away from the inlet port 312 and toward the housing cap 330. For example, the biasing mechanism 340 may be a compression spring, an extension spring, a torsion spring, or the like. In various embodiments, the biasing mechanism 340 comprises a compression spring 342 disposed between the housing cap 330 and the inlet port 312. In various embodiments, if a tension spring were used, the tension spring would be disposed on an opposite side of the poppet 320 and configured to provide a pulling force on the poppet 320 axially towards the inlet cavity 360 in response to the poppet 320 travelling axially towards the housing cap 330.

In various embodiments, the pilot pressure inlet port 316 is in fluid communication with a command cavity 350. The command cavity 350 may be defined by the poppet 320, the valve housing 310, and the housing cap 330, in accordance with various embodiments. In various embodiments, in response to the solenoid valve 210 being open, a first fluid pressure force in the command cavity 350 may be greater than a second fluid pressure force at the inlet port 312, which will cause the poppet 320 to close the outlet port 314. In this regard, in response to the poppet 320 being in a closed position, the outlet port 314 is sealed from the command cavity 350 and the inlet port 312, in accordance with various embodiments.

For example, the pneumatic valve 220 may further comprise a first seal 322 and a second seal 324. In various embodiments, the first seal 322 is configured to seal the command cavity 350 from the outlet port 314 independent of whether the pneumatic valve 220 is in an open position or a closed position. In various embodiments, the second seal 324 is configured to seal the inlet port 312 from the outlet port 314 in response to the pneumatic valve 220 is in a closed position. In various embodiments, the poppet 320 may include an annular face groove at an axial end of the poppet 320 proximate the inlet port 312, the annular face groove configured to house the second seal 324. Similarly, the poppet 320 may include a radial groove disposed in a circumferential face of the poppet 320 and configured to house the first seal 322.

In various embodiments, the first seal 322 and the second seal 324 may be any seal known in the art. In various embodiments, the first seal 322 comprises a dynamic radial seal, such as an O-ring (e.g., an annular elastomeric gasket). In various embodiments, the second seal 324 may comprise a face seal (e.g., a seal having sealing surfaces that are normal to the axis of the seal). In various embodiments, the valve housing 310 further comprises a seal land 318 disposed proximate the inlet port 312. The seal land 318 is configured to interface with the second seal 324 in response to the poppet 320 being pressurized into a closed position. In various embodiments, the first seal 322 has a greater diameter than the second seal 324. In this regard in response to the solenoid valve 210 being in energized, a losing force may act on the poppet 320 axially towards the inlet port 312 and ensure a leak tight seal. In various embodiments, the first seal 322 maintains unobstructed contact with a radially inner surface of the valve housing 310 during translation of the poppet 320 from open to closed and vice versa.

Referring now to FIG. 4B, a schematic view of the valve module 200 with a detail schematic of the pneumatic valve 220 is illustrated in an open position, in accordance with various embodiments. In various embodiments, the solenoid valve 210 may receive a command signal 102 from controller 110 from FIG. 3 to energize the solenoid valve 210. In response to the solenoid valve 210 being energized, the solenoid valve may close and seal fluid communication between the command cavity 350 and the compressed fluid source 32 from FIG. 3. In this regard, in response to the solenoid valve 210 being in a closed position (e.g., an energized state), the pilot pressure inlet port 316 of the valve housing 310 is fluidly coupled to a vent port of the solenoid valve 210 as described further herein. Thus, the first pressure in the command cavity 350 is ambient and the second pressure in an inlet cavity 360 generates an opening force greater than a spring force of the biasing mechanism 340. Therefore, in response to the solenoid valve 210 being closed (e.g., in an energized state), the poppet 320 may translate axially away from inlet port 312 and toward the housing cap 330 and fluidly couple the inlet port 312 to the outlet port 314, in accordance with various embodiments. The opening force and the spring force then reach an equilibrium and maintain an open position of the poppet 320.

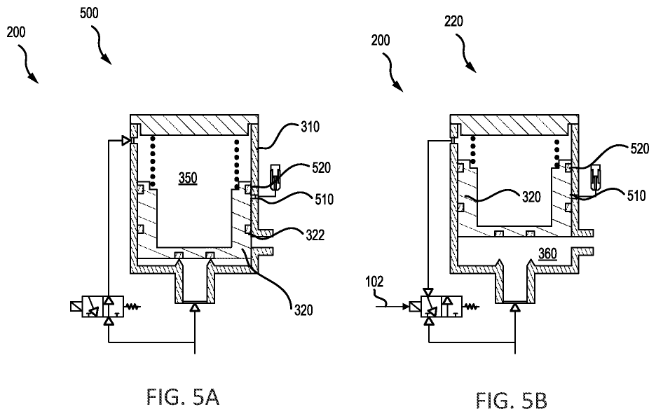

Referring now to FIG. 5A, a schematic view of the valve module 200 with a detail schematic of a pneumatic valve 500 is illustrated in a closed position, in accordance with various embodiments. In various embodiments, the pneumatic valve 500 is in accordance with the pneumatic valve 220 except as described further herein. In various embodiments, the pneumatic valve 500 further comprises a vent fitting 510 coupled to the valve housing 310. In various embodiments, the poppet 320 of the pneumatic valve 500 further comprises a third seal 520. In various embodiments, the third seal 520 is in accordance with the first seal 322 from FIG. 4A. For example, the third seal 520 may comprise a dynamic radial seal. In various embodiments, the vent fitting 510 may be disposed axially between the first seal 322 and the third seal 520. The third seal 520 may increase a life cycle for the pneumatic valve 500 relative to typical pneumatic valves, in accordance with various embodiments. For example, if the third seal 520 degrades from the dynamic motion over time, minute leakage from the inlet cavity 360 may be vented through the vent fitting 510 to ambient when the poppet 320 is in a closed position.

Referring now to FIG. 5B, a schematic view of the valve module 200 with a detail schematic of the pneumatic valve 500 is illustrated in an open position, in accordance with various embodiments. In various embodiments, the vent fitting 510 may remain between the first seal 322 and the third seal 520 in response to the poppet 320 being in an open position. The third seal 520 may increase a life cycle for the pneumatic valve 500 relative to typical pneumatic valves, in accordance with various embodiments. For example, if the first seal 322 degrades from the dynamic motion over time, minute leakage from the command cavity 350 may be vented through the vent fitting 510 to ambient when the poppet 320 is in an open position.

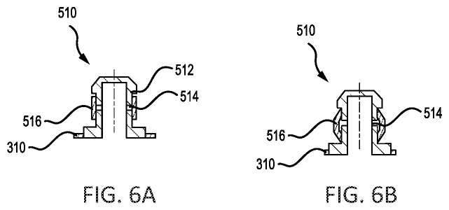

Referring now to FIG. 6A a detail view of the vent fitting 510 coupled to the valve housing 310 is illustrated in a closed position, in accordance with various embodiments. A closed position for the vent fitting is when there is no leakage, in accordance with various embodiments. The vent fitting 510 may comprise a fitting body 512 defining a channel, at least one outlet port 514, and an elastomeric sleeve 516 disposed around the fitting body 512 and configured to cover at least one outlet port 514 in response to the vent fitting 510 being in a closed position. In various embodiments, the fitting body 512 may be coupled to the valve housing 310 by welding, brazing, or the like.

Referring now to FIG. 6B, a detail view of the vent fitting 510 coupled to the valve housing 310 is illustrated in an open position, in accordance with various embodiments. An open position for the vent fitting is when there is fluid is configured to leak out the at least one outlet port 514 past the elastomeric sleeve 516. For example, the elastomeric sleeve 516 may expand in response to pressure from leaked fluid and allow the leaked fluid to vent to ambient through a vent channel, in accordance with various embodiments.

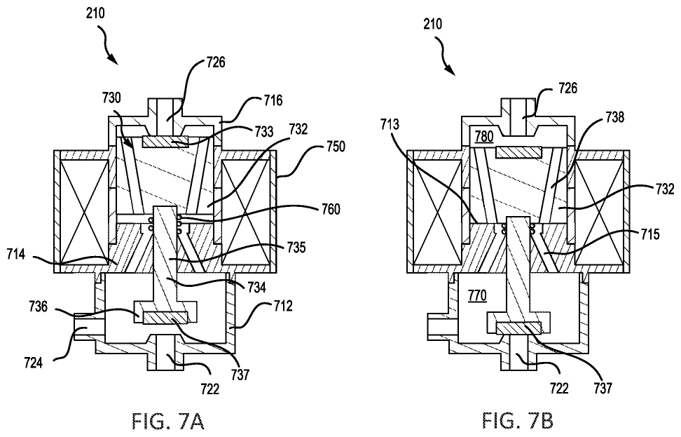

Referring now to FIG. 7A, a cross-sectional view of the solenoid valve 210 is illustrated in a de-energized position, in accordance with various embodiments. In various embodiments, the solenoid valve 210 comprises a valve body 710. In various embodiments, the valve body 710 is a static component of the solenoid valve 210 (i.e., the valve body 710 does not move during operation of the solenoid valve 210). In various embodiments, the valve body may comprise several pieces (e.g., a first axial portion 712, a solenoid core 714, and a second axial portion 716). In various embodiments, the various pieces may facilitate assembly of the solenoid valve 210.

In various embodiments, the valve body 710 further comprises an inlet port 722, an outlet port 724, and a vent port 726. The inlet port 722 is disposed at a first axial end of the valve body 710 and disposed axially through the first axial portion 712 of the valve body 710, in accordance with various embodiments. The outlet port 724 is disposed at a second axial end of the valve body 710 and disposed axially through the second axial portion 716 of the valve body 710, in accordance with various embodiments. The outlet port 724 is disposed radially through the first axial portion 712 of the valve body 710 in accordance with various embodiments.

In various embodiments, the solenoid valve 210 further comprises an actuator 730 having a plunger 732 and a poppet rod 734. The plunger 732 may be coupled to the poppet rod 734 by any method known in the art, such as a threaded coupling, a press fit, or the like. The plunger 732 is disposed proximate the vent port 726. The poppet rod 734 includes a shaft 735 coupled to the plunger 732 and a poppet 736 disposed proximate the inlet port 722. In various embodiments, the actuator 730 further comprises a vent port seal 733 coupled to the plunger 732 and disposed at a first axial end of the actuator 730, and the actuator 730 further comprises an inlet port seal 737 coupled to the poppet 736 and disposed at a second axial end of the actuator 730, the second axial end being disposed axially opposite the first axial end.

In various embodiments, the plunger 732 is biased in a closed position. For example, a spring 760 may be disposed between the plunger 732 and the solenoid core 714. In various embodiments, the spring 760 is a compression spring and configured to compress the plunger 732 against the vent port 726 to seal the vent port 726 in a de-energized position. Additionally, the poppet 736 is configured to be spaced apart from the inlet port 722 in the de-energized position. In this regard, the solenoid valve 210 is configured as a normally open three-way solenoid valve, in accordance with various embodiments.

In various embodiments, the solenoid valve 210 further comprises a solenoid coil 750.

The solenoid coil 750 comprises a conductive metallic wire wound into a cylindrical shape and is disposed radially outward of the actuator 730. A max air gap for the solenoid valve 210 is disposed between the plunger 732 and the solenoid core 714. In various embodiments, the solenoid coil 750 is in electrical communication with controller of an inflation system (e.g., the controller 110 from FIG. 3).

In various embodiments, as the inlet port 722 receives a pressurized fluid (e.g., from compressed fluid source 32 from FIG. 3), the pressurized fluid flows through the outlet port 724 to the command cavity 350 of the pneumatic valve 220, 500 as described previously herein. In various embodiments, in the de-energized position, a pressure force may be exerted on the actuator axially toward the vent port 726. In this regard, the pressure force may provide an additional sealing force for the vent port seal 733. In various embodiments, utilizing the additional sealing force may provide a more efficient leak tight seal relative to typical solenoid valves.

Referring now to FIG. 7B, a cross-sectional view of the solenoid valve 210 is illustrated in an energized position, in accordance with various embodiments. In response to a current being supplied to the solenoid coil 750, the plunger 732 translates axially towards a stator pole face 713 of the solenoid core 714 and overcomes a spring force of the spring 260 and a pressure force of the pressurized fluid. In various embodiments, in response to being energized, the inlet port seal 737 is compressed against the inlet port 722 creating a leak tight seal between the inlet port 722 and a main cavity 770.

In various embodiments, in the energized state, the outlet port 724 is in fluid communication with the vent port 726 and configured to vent the pressurized fluid from the command cavity of pneumatic valve 220 from FIGS. 4A-5B. In this regard, the solenoid core 714 may comprise a fluid conduit 715. Any number of fluid conduits may be disposed through the solenoid core. Similarly, the plunger 732 may comprise a fluid conduit 738 disposed therethrough. The plunger 732 may include any number of fluid conduits as well. However, the number of fluid conduits in the plunger 732 should match the number of fluid conduits in the solenoid core 714. Additionally, each fluid conduit in the plunger 732 should align with an axially adjacent fluid conduit in the solenoid core 714 in response to the solenoid valve being energized. In this regard, the main cavity 770 is fluidly coupled to a vent cavity 780 in the energized state. Thus, pressurized air from the command cavity 350 of the pneumatic valve 220 from FIGS. 4A-5B may be vented back through outlet port 724 into main cavity 770 through fluid conduits 715, 738 into vent cavity 780 and out the vent port 726.

In various embodiments, in response to the solenoid valve 210 being energized, a solenoid force is developed across the air gap between the plunger 732 and the stator pole face 713 of the solenoid core 714. In response to the solenoid force, the inlet port 722 is sealed by the inlet port seal 737. From the energized (e.g., actuated) state illustrated in FIG. 7B, de-energizing the solenoid valve 210 will cause the spring 760 to push the plunger axially back to the de-energized position illustrated in FIG. 7A.

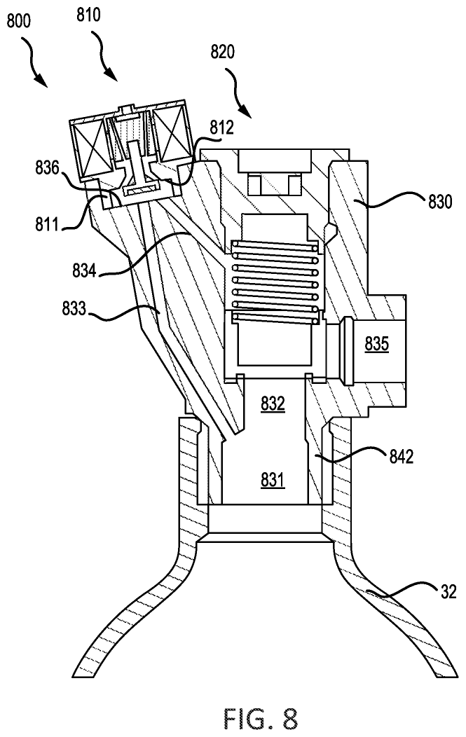

Referring now to FIG. 8, a schematic view of a valve assembly is illustrated, in accordance with various embodiments. In various embodiments, the valve assembly 800 comprises a solenoid valve 810 and a pneumatic valve 820 for use in the inflation system 100 from FIGS. 1 and 2. In various embodiments, the solenoid valve 810 is in accordance with the solenoid valve 210, except as further described herein. Similarly, the pneumatic valve 820 is may be in accordance with either the pneumatic valve 220 or the pneumatic valve 500, except as described further herein.

In various embodiments, the valve assembly 800 further comprises a valve housing 830. The valve housing 830 may define a main valve inlet port 831, a pneumatic valve inlet port 832, an internal pilot conduit 833, an internal command feed conduit 834, and an outlet port 835. In various embodiments, the main valve inlet port 831 is in fluid communication with the pneumatic inlet port 832 and the internal pilot conduit 833. In various embodiments, the internal pilot conduit 833 is configured to act as an inlet port for the solenoid valve 810 (e.g., inlet port 722 from FIG. 7). Similarly, the internal command feed conduit 834 is configured to act as an outlet port for the solenoid valve 810 (e.g., outlet port 724 from FIG. 7) and a pilot pressure inlet for the pneumatic valve 820 (e.g., pilot pressure inlet port 316 from FIGS. 4A-5B).

In various embodiments, the valve assembly 800 may be configured to be mechanically and fluidly coupled the to a compressed fluid source 32, such as a pressurized gas bottle, or the like. For example, the valve housing 830 may comprise a coupling end 842 disposed proximate the inlet port. The coupling end 842 may be any coupling end known in the art, such as a mail threaded end, a female threaded, end, a press fit end, or the like. Similarly, the outlet port 835 of the valve assembly 800 may be configured to be mechanically and fluidly coupled to a pipe assembly, or directly to a pressure regulator, via a threaded connection, a press fit, or the like.

In various embodiments, the solenoid valve 810 includes a first axial end 811 defining a recess 812. In various embodiments, the recess 812 and a recess 836 of the valve housing 830 may define a main cavity (e.g., main cavity 770 from FIG. 7B) for the solenoid valve 810. In this regard, the first axial end 811 may be coupled to the recess 836 of the valve main body by a threaded connection, press fit, or the like. In various embodiments, the remainder of the solenoid valve 810 is in accordance with the solenoid valve 210 from FIG. 7. Similarly, in various embodiments, the remainder of the pneumatic valve 820 may be in accordance with the pneumatic valve 220 from FIGS. 4A-4B or the pneumatic valve 500 from FIGS. 5A-5B.

In various embodiments, the pneumatic valves 220, 500, 820 benefit from having only a single moving part (e.g., the poppet 320). In various embodiments, the various seals (e.g., the seals 322, 324, 520) may comprise polymer materials, such as polychlorotrifluoroethylene (PCTFE), polyether ether ketone (PEEK), or the like. In various embodiments, the seals configured for flat sealing (e.g., seal 324) may be custom designed to achieve optimal leak tightness for the pneumatic valves 220, 500, 820. In various embodiments, the seals configured for dynamic sliding (e.g., seals 322, 520) may not pass through any open cutouts of the valve housing, which may prevent degradation of the seals, resulting in longer seal life relative to typical pneumatic valves. In various embodiment, redundant dynamic radial sealing (e.g., seals 322, 520 from FIGS. 5A-5B) may further improve leak tightness of the pneumatic valves 220, 500, 820 relative to typical pneumatic valves. In various embodiments, the leak tightness of the pneumatic valves 220, 500, 820 may further be improved relative to typical pneumatic valves by including a vent fitting 510 from FIGS. 6A-6B.

In various embodiments, the solenoid valves 210, 810 disclosed herein may be manufactured in a smaller design space relative to typical solenoid valves by using two flat seals (e.g., seals 733, 737) disposed axially opposite each other. In various embodiments, the two flat seals (e.g., seals 733, 737) may be designed to achieve optimal leak tightness using polymer material, such as PCTFE, PEEK, or the like. In various embodiments, the solenoid valves 210, 810 may be manufactured via an all welded construction, namely welding between the first axial portion 712 and the solenoid core 714, welding between the solenoid core 714 and the solenoid coil 750, and welding between the solenoid core 714 and the second axial portion 716. In various embodiments, by manufacturing the solenoid valves 210, 810 via all welded constructions, static seals from typical solenoid valves may be eliminated.

A method for using a pneumatic valve is disclosed herein. The method may comprise:

receiving, from a pressurized fluid source and through a three-way normally open solenoid valve, a pressurized fluid in a command cavity of the pneumatic valve, the command cavity being defined by a housing cap, a valve housing, and poppet disposed in the valve housing; receiving, from the pressurized fluid source and through an inlet port defined by the valve housing, the pressurized fluid; sealing the inlet port via an annular face seal in response to a first pressure in the command cavity being greater than a second pressure in the inlet port; and translating the poppet axially within the valve housing to fluidly couple the inlet port to an outlet port defined by the valve housing in response to the three-way normally open solenoid valve being energized , the pneumatic valve comprising a first dynamic radial seal coupled to the poppet and in intimate contact with a radially inner surface of the valve housing, the first dynamic radial seal configured to maintain intimate contact with the radially inner surface in response to translating axially.

In various embodiments, the method may further comprise translating, via a biasing mechanism, the poppet axially towards the inlet port in response to the three-way normally open solenoid valve being de-energized. The biasing mechanism may comprise a compression spring disposed between the housing cap and the poppet. The method may further comprise venting, via a vent fitting coupled to the valve housing, leaked fluid in response to the pressurized fluid leaking past the first dynamic radial seal, the vent fitting being disposed axially between the first dynamic radial seal and a second dynamic radial seal.

A valve assembly is disclosed herein. The valve assembly may comprise: a valve main body defining a first inlet port, a first outlet port, and a vent port, the first inlet port disposed at a first axial end of the valve main body, the vent port disposed at a second axial end of the valve main body; a solenoid core; a solenoid coil disposed radially outward of the solenoid core; a plunger disposed axially between the solenoid core and the vent port, the plunger separated axially from the solenoid core by an air gap, the plunger configured to seal the vent port in response to the solenoid coil being in a de-energized state; a poppet rod extending from the plunger through the solenoid core into a main cavity; a first poppet coupled to the poppet rod and disposed proximate the first inlet port, the first poppet configured to seal the first inlet port in response to the solenoid coil being in an energized state.

In various embodiments, the plunger includes a first fluid conduit and the solenoid core includes a second fluid conduit. The first outlet port may be fluidly coupled to the vent port through the first fluid conduit and the second fluid conduit in response to the solenoid coil being energized. The valve assembly may further comprise a compression spring disposed between the solenoid core and the plunger, the compression spring configured to bias the plunger toward the vent port. The valve assembly may further comprise a first face seal proximal the first inlet port and a second face seal proximal the vent port, wherein the first face seal is configured to seal the vent port in response to the solenoid coil being de-energized, and wherein the second face seal is configured to seal the first inlet port in response to the solenoid coil being energized. The first face seal may be coupled to the first poppet, and the second face seal may be coupled to the plunger. The valve main body may further comprise a first axial portion and a second axial portion. The first axial portion may include the first inlet port and the first outlet port. The second axial portion may include the vent port. The first axial portion may be coupled to the solenoid core. The second axial portion may be coupled to the solenoid core. The first axial portion may be welded to the solenoid core, and the second axial portion may be welded to the solenoid core. The plunger, the first poppet, and the poppet rod may be configured to translate axially towards the first inlet port in response to the solenoid coil being energized. A compression spring may be configured to bias the plunger, the first poppet, and the poppet rod back axially towards the vent port in response to the solenoid coil being de-energized. The valve assembly may further comprise a valve housing. The valve housing may further comprise an internal pilot conduit and a command feed conduit. The internal pilot conduit may extend from a main inlet port of the valve housing to the first inlet port. The command feed conduit may extend from the first outlet port to a pilot pressure inlet port of a pneumatic valve. The valve housing may further comprise a second inlet port and a second outlet port. The pneumatic valve may further comprise: a second poppet defining an axial surface and a radially outer surface, the second poppet including a first radial groove disposed in the radially outer surface; a first dynamic radial seal disposed in the first radial groove and in intimate contact with a radially inner surface of the valve housing, the first dynamic radial seal configured to maintain intimate contact with the radially inner surface of the valve housing in response to the second poppet translating axially from an open position to a closed position.

An inflation system is disclosed herein. The inflation system may comprise: a compressed fluid source; an aspirator; a pneumatic valve having a first inlet port, a first outlet port, and a pilot pressure inlet port, the first inlet port in fluid communication with the compressed fluid source, the first outlet port in fluid communication with the aspirator; and a solenoid valve, comprising: a second inlet port, the compressed fluid source in fluid communication with the second inlet port; a second outlet port, the second outlet port in fluid communication with the pilot pressure inlet port; and a vent port, the second inlet port disposed axially opposite the vent port; a solenoid coil; a solenoid core disposed radially inward from the solenoid coil; a plunger disposed axially between the solenoid core and the vent port, the plunger being biased toward the vent port in response to the solenoid coil being de-energized, the plunger configured to create a vent seal with the vent port in response to the solenoid coil being de-energized, a poppet rod extending from the plunger through the solenoid core proximal the second inlet port, and a poppet coupled to the poppet rod proximal the second inlet port, the poppet configured to translate axially towards the second inlet port in response to the solenoid coil being energized and create an inlet seal with the second inlet port.

The inflation system may further comprise an inflatable slide coupled to the aspirator.

The plunger may include a first fluid conduit and the solenoid core includes a second fluid conduit. The second outlet port may be fluidly coupled to the vent port through the first fluid conduit and the second fluid conduit in response to the solenoid coil being energized. The inflation system may further comprise a valve housing including a recess, wherein: the solenoid valve is coupled to the recess; the valve housing further comprises an internal pilot conduit and a command feed conduit, the internal pilot conduit extends from a main inlet port of the valve housing to the first inlet port, the first inlet port being disposed in the recess, and the command feed conduit extends from the first outlet port to the pilot pressure inlet port of the pneumatic valve, the first outlet port being disposed in the recess.

A method for using a solenoid valve is disclosed herein. The method may comprise:

receiving, from a controller and through an electrical connection, a current to energize the solenoid valve; generating, via a solenoid coil and a solenoid core, an electric field within the solenoid valve; translating a plunger, a poppet rod, and a poppet axially away from a vent port of the solenoid valve and towards an inlet port of the solenoid valve in response to the electric field being generated; sealing the inlet port with the poppet in response to a first face seal being compressed at the inlet port; and venting a pressurized fluid from a command cavity of a pneumatic valve from an outlet port through a first fluid conduit in the solenoid core through a second fluid conduit in the plunger, and out the vent port.

The method may further comprise translating, via a biasing mechanism, the plunger, the poppet rod, and the poppet axially towards the vent port in response to the solenoid coil being de-energized. The biasing mechanism may comprise a compression spring disposed between the solenoid core and the plunger. The method may further comprise sealing, via a second face seal coupled to the plunger, the vent port in response to the solenoid coil being de-energized.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A valve assembly, comprising:
a housing cap;
a valve housing having an inlet port, an outlet port, and a pilot pressure inlet port, the inlet port disposed axially opposite the housing cap;
a poppet defining an axial surface and a radially outer surface, the poppet including a first radial groove disposed in the radially outer surface;
a first dynamic radial seal disposed in the first radial groove and in intimate contact with a radially inner surface of the valve housing, the first dynamic radial seal configured to maintain unobstructed contact with the radially inner surface of the valve housing in response to the poppet translating axially from an open position to a closed position.

2. The valve assembly of claim 1, further comprising a face seal, wherein:
the poppet further comprises an annular face groove disposed in the axial surface, and
the face seal is disposed in the annular face groove.

3. The valve assembly of claim 2, wherein the face seal is configured to seal the inlet port in response to the valve assembly being in the closed position.

4. The valve assembly of claim 1, further comprising a second dynamic radial seal, wherein:
the poppet further comprises a second radial groove disposed in the radially outer surface, the second radial groove being spaced apart axially from the first radial groove, and
the second dynamic radial seal is disposed in the second radial groove.

5. The valve assembly of claim 4, further comprising a vent fitting coupled to the valve housing, the vent fitting disposed axially between the first dynamic radial seal and the second dynamic radial seal.

6. The valve assembly of claim 5, wherein the vent fitting remains axially between the first dynamic radial seal and the second dynamic radial seal in response to the poppet translating axially to open the valve assembly.

7. The valve assembly of claim 1, wherein:
the housing cap and the poppet at least partially define a command cavity,
the command cavity is in fluid communication with the pilot pressure inlet port, and
the valve assembly is configured to bias the poppet axially towards the inlet port in response to the command cavity and the inlet port being exposed to similar pressure from a pressurized fluid.

8. The valve assembly of claim 7, further comprising a biasing mechanism configured to bias the poppet axially towards the inlet port.

9. The valve assembly of claim 8, wherein the biasing mechanism comprises a compression spring extending from the housing cap to the poppet.

10. The valve assembly of claim 1, wherein:
the valve housing further comprises an internal pilot conduit and a command feed conduit,
the internal pilot conduit extends from the inlet port to a solenoid inlet port of a three-way normally open solenoid valve, and
the command feed conduit extends from a solenoid outlet port of the three-way normally open solenoid valve to the pilot pressure inlet port of the inlet port.

11. The valve assembly of claim 10, wherein the three-way normally open solenoid valve further comprises:
a plunger configured to seal a vent port in response to the three-way normally open solenoid valve being in a de-energized state;
a poppet rod extending axially from the plunger to a second poppet, the poppet rod extending towards the solenoid inlet port; and
an inlet port face seal coupled to the second poppet, the inlet port face seal configured to seal the solenoid inlet port in response to the three-way normally open solenoid valve being in an energized state.

12. An inflation system, comprising:
a compressed fluid source;
an aspirator;
a three-way normally open solenoid valve having a first inlet port, a first outlet port, and a first vent port, the compressed fluid source in fluid communication with the first inlet port; and
a pneumatic valve, comprising:
a housing cap disposed at a first axial end of the pneumatic valve;
a valve housing defining a second inlet port, a second outlet port, and a pilot pressure inlet port, the first outlet port of the three-way normally open solenoid valve in fluid communication with the pilot pressure inlet port, the compressed fluid source in fluid communication with the second inlet port, and the second outlet port in fluid communication with the aspirator, the second inlet port disposed at a second axial end of the pneumatic valve, the second axial end being axially opposite the first axial end; and
a poppet disposed axially between the housing cap and the second inlet port, the poppet configured to seal the second inlet port in response to the three-way normally open solenoid valve being in a de-energized sate, and the poppet configured to translate axially toward the housing cap and fluidly couple the second inlet port and the second outlet port in response to the three-way normally open solenoid valve being an energized state.

13. The inflation system of claim 12, further comprising an inflatable slide coupled to the aspirator.

14. The inflation system of claim 12, further comprising a first dynamic radial seal coupled to the poppet, the first dynamic radial seal being in unobstructed contact with a radially inner surface of the valve housing, the first dynamic radial seal configured to maintain intimate contact with the radially inner surface in response to translating axially within the valve housing.

15. The inflation system of claim 14, wherein the pneumatic valve further comprises a face seal coupled to the poppet and configured to seal the second inlet port in response to the three-way normally open solenoid valve being in a de-energized state.

16. The inflation system of claim 15, wherein the pneumatic valve further comprises a second dynamic radial seal and a vent fitting, the second dynamic radial seal being spaced apart axially from the first dynamic radial seal and coupled to the poppet , the vent fitting coupled to the valve housing and disposed axially between the first dynamic radial seal and the second dynamic radial seal.

17. A valve assembly, comprising:
a valve main body defining a first inlet port, a first outlet port, and a vent port, the first inlet port disposed at a first axial end of the valve main body, the vent port disposed at a second axial end of the valve main body;
a solenoid core;
a solenoid coil disposed radially outward of the solenoid core;
a plunger disposed axially between the solenoid core and the vent port, the plunger separated axially from the solenoid core by an air gap, the plunger configured to seal the vent port in response to the solenoid coil being in a de-energized state;
a poppet rod extending from the plunger through the solenoid core into a main cavity;
a first poppet coupled to the poppet rod and disposed proximate the first inlet port, the first poppet configured to seal the first inlet port in response to the solenoid coil being in an energized state.

18. The valve assembly of claim 17, wherein the plunger includes a first fluid conduit and the solenoid core includes a second fluid conduit.

19. The valve assembly of claim 18, wherein the first outlet port is fluidly coupled to the vent port through the first fluid conduit and the second fluid conduit in response to the solenoid coil being energized.

20. The valve assembly of claim 17, further comprising a compression spring disposed between the solenoid core and the plunger, the compression spring configured to bias the plunger toward the vent port.
